(19) United States
(12) Patent Application Publication
(10) Pub. No.: US 2017/0149905 A1
(43) Pub. Date: May 25, 2017

(54) SYSTEM AND METHOD FOR PEER-TO-PEER CONNECTIVITY ACROSS FEDERATED DOMAINS

(71) Applicant: DAMAKA, INC., Richardson, TX (US)

(72) Inventors: SIVAKUMAR CHATURVEDI, ALLEN, TX (US); SATISH GUNDABATHULA, IRVING, TX (US)

(21) Appl. No.: 15/422,810

(22) Filed: Feb. 2, 2017

Related U.S. Application Data
(63) Continuation of application No. PCT/US15/43633, filed on Aug. 4, 2015.
(60) Provisional application No. 62/033,428, filed on Aug. 5, 2014.

(51) Int. Cl. H04L 29/08

(52) U.S. Cl. CPC H04L 67/141; H04L 67/1059

(57) ABSTRACT

An improved system and method are disclosed for connectivity in a federated domain relationship. In one example, the method includes sending a request for a federated domain relationship from a first domain to a second domain. The federated domain relationship enables endpoints within each domain to communicate with endpoints in the other domain. A response is received indicating that the request is granted. Information about the first domain is sent to the second domain and information about the second domain is received by the first domain. At least a portion of the information about the second domain is sent to endpoints in the first domain.

### CROSS-REFERENCE TO RELATED APPLICATIONS

This application is a continuation of International PCT Application No. PCT/US15/43633, filed on Aug. 4, 2015, entitled SYSTEM AND METHOD FOR PEER-TO-PEER CONNECTIVITY ACROSS FEDERATED DOMAINS (Atty. Dkt. No. DAMA-32759). International PCT Application No. PCT/US15/43633 claims benefit of and/or priority to U.S. Provisional Application No. 62/033,428, filed on Aug. 5, 2014, entitled SYSTEM AND METHOD FOR PEER-TO-PEER CONNECTIVITY ACROSS FEDERATED DOMAINS (Atty. Dkt. No. DAMA-32310). Application Nos. PCT/US15/43633 and 62/033,428 are incorporated by reference herein in their entirety.

### BACKGROUND

Communications systems often have limitations that affect communications across system boundaries. Accordingly, what is needed are a system and method that addresses such issues.

### BRIEF DESCRIPTION OF THE DRAWINGS

For a more complete understanding, reference is now made to the following description taken in conjunction with the accompanying Drawings in which:

FIG. 1 illustrates one embodiment of an environment with multiple domains;

FIG. 2 illustrates a sequence diagram of one embodiment of a process that may be executed to establish a federated domain relationship within the environment of FIG. 1;

FIG. 3 illustrates a flow chart of one embodiment of a process by which an access server may attempt to establish a federated domain relationship within the environment of FIG. 1;

FIG. 4 illustrates a flow chart of one embodiment of a process by which an access server may respond to an attempt to establish a federated domain relationship within the environment of FIG. 1;

FIG. 5 illustrates a sequence diagram of one embodiment of a process that may be executed to establish a buddy relationship between endpoints in different domains within the environment of FIG. 1;

FIG. 6 illustrates a flow chart of one embodiment of a process by which an access server may aid in establishing a buddy relationship between two endpoints within the environment of FIG. 1;

FIG. 7 illustrates a flow chart of another embodiment of a process by which an access server may aid in establishing a buddy relationship between two endpoints within the environment of FIG. 1;

FIG. 8 illustrates a flow chart of one embodiment of a process by which a link server may aid in establishing a buddy relationship between two endpoints within the environment of FIG. 1;

FIG. 9 illustrates a flow chart of one embodiment of a process by which an endpoint may attempt to establish a buddy relationship with another endpoint within the environment of FIG. 1;

FIG. 10 illustrates one embodiment of an environment within which multiple paths may be available for communications between endpoints in federated domains;

FIG. 11 illustrates one embodiment of an environment within which multiple federated domains are present; and

FIG. 12 illustrates one embodiment of a system that may be used within the environment of FIG. 1.

### DETAILED DESCRIPTION

It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

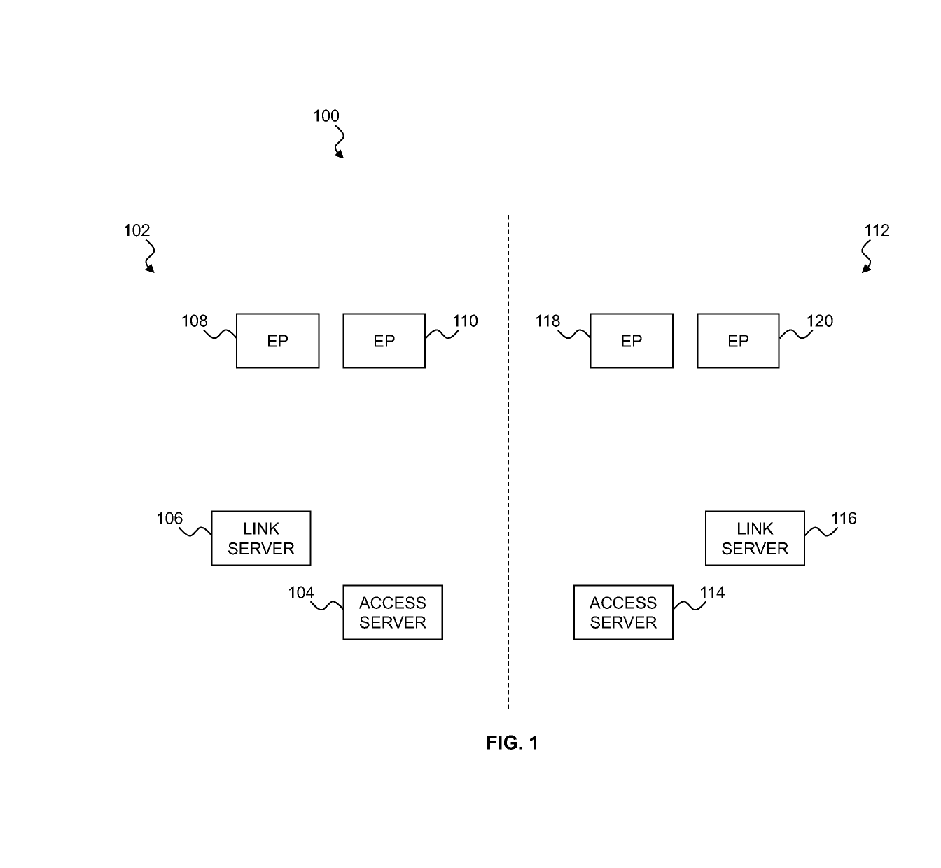

Referring to FIG. 1, one embodiment of an environment 100 is illustrated with a domain 102 and a domain 112. In the present example, the domains 102 and 112 are separately controlled peer-to-peer networks. Accordingly, each domain 102 and 112 has its own infrastructure.

The infrastructure of the domain 102 includes an access server 104 and a link server 106, which may be combined into a single server in some embodiments. The access server 104 and link server 106 provide support to endpoints (EPs) within the domain 102, such as endpoints 108 and 110. The endpoints 108 and 110 can communicate with each other (assuming they are buddies) because they are in the same domain 102.

Various interactions between the endpoints 108 and 110 and between the endpoints and the access server 104/link server 106 within the single domain 102 are described in U.S. Pat. No. 8,725,895, filed on Feb. 15, 2010, and entitled NAT TRAVERSAL BY CONCURRENTLY PROBING MULTIPLE CANDIDATES, which is hereby incorporated by reference in its entirety. Such interactions include logging an endpoint into the peer-to-peer network represented by the domain 102 via the access server 104, adding and removing endpoints as buddies, discovering routes to use for communication sessions, establishing communication sessions, and similar processes that may be used within a single domain.

The infrastructure of the domain 112 includes an access server 114 and a link server 116, which may be combined into a single server in some embodiments. The access server 114 and link server 116 provide support to endpoints within the domain 112, such as endpoints 118 and 120. The endpoints 118 and 120 can communicate with each other (assuming they are buddies) because they are in the same domain 112.

In the present embodiment, the domains 102 and 112 are similar or identical. Accordingly, the access server 104 is similar or identical to the access server 114 from a functionality standpoint, and the link server 106 is similar or identical to the link server 116 from a functionality standpoint. Each domain 102 and 112 may include many endpoints, each of which is registered with the access server of its respective domain in order to access the peer-to-peer network of that domain.

Because the domains 102 and 112 are separate, the endpoints in one domain cannot connect to the endpoints in the other domain in the same manner that they can connect to endpoints within the same domain. For example, the endpoint 108 may send a connection request directly to the endpoint 110 as described in U.S. Pat. No. 8,725,895 because both the endpoint 108 and the endpoint 110 are in the same domain 102. However, the endpoint 108 cannot send a connection request directly to the endpoint 118 because the endpoint 108 is in the domain 102 and the endpoint 118 is in the domain 112. The access servers 104 and 114 control access to their respective domains and will only permit access to endpoints that are registered with that access server.

To address this issue, the domains 102 and 112 may become federated domains, which means that the two domains establish a level of trust. This trust enables communications to occur between endpoints that are in different domains, subject to user preferences (e.g., whether a buddy request is accepted or rejected) and/or various policies that may be implemented by one or both of the domains. Accordingly, inter-domain communications may occur between federated domains, but some processes may differ from intra-domain communications due to the way the infrastructure of each domain operates.

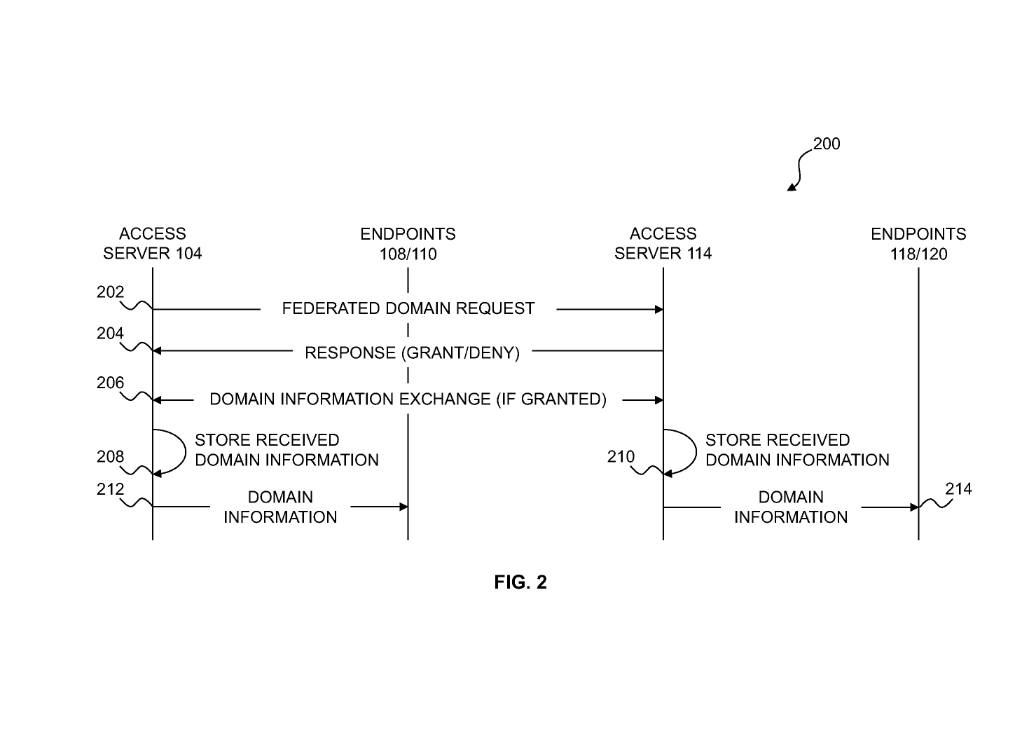

Referring to FIG. 2, a sequence diagram 200 illustrates one embodiment of a process that may be executed to create a federated domain relationship between the domains 102 and 112. It is understood that a single domain may have a federated domain relationship with many other domains, and that those domains may or may not have federated domain relationships with each other.

In step 202, the domain 102 initiates the federated domain relationship by sending a request to the domain 112. For example, the access server 104 may send a federated domain request to the access server 114. In step 204, the access server 114 responds and either grants or denies the federated domain request. If the federated domain request is accepted, the domains 102 and 112 will become federated domains and their respective endpoints will be able to communicate. If the request is denied, the two domains 102 and 112 will remain separate and their respective endpoints will continue to operate only within their own domains. If the federated domain request is denied, step 204 would be the last step.

In the present example, the federated domain request is accepted. In step 206, the access servers 104 and 114 exchange domain information, such as the network addresses for one or more link servers (e.g., Internet Protocol (IP) address information). As will be described below, the endpoints in each domain may leverage the infrastructure in the other domain to communicate and need to know certain information in order to do so.

In step 208, the access server 104 stores the received information. In step 210, the access server 114 stores the received information. In step 212, the access server 104 sends the received link server information and information about available federated domain pairs to the endpoints within its domain (e.g., the endpoints 108 and 110). In step 214, the access server 114 sends the received link server and access server information to the endpoints within its domain (e.g., the endpoints 118 and 120).

It is understood that while the request and response of steps 202 and 204 may occur a single time to establish the federated domain relationship, steps 206-214 may repeat as needed. For example, if an update occurs within the domain 102, the access server 104 may send an update to the access server 114, and the access server 114 would store the information and send the information (if necessary) to the endpoints within the domain 112. Such updates may occur any time a domain's information is changed or may occur periodically (e.g., at timed intervals).

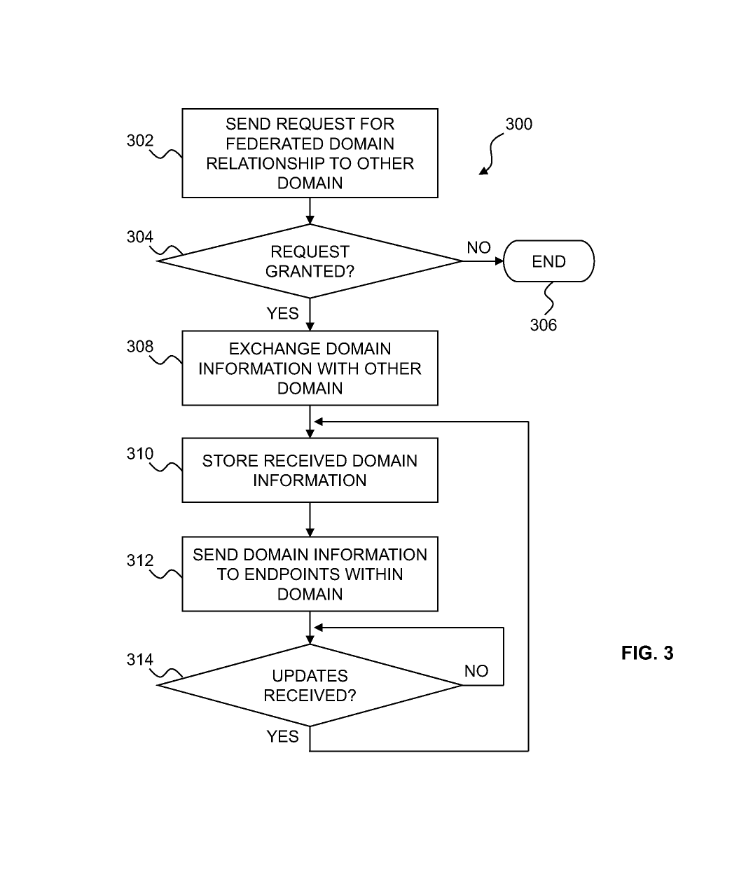

Referring to FIG. 3, a method 300 illustrates one embodiment of a process that may be executed by an access server (e.g., the access server 104 of FIG. 1) to establish a federated domain relationship. For purposes of example, the access server 104 is communicating with the access server 114 to establish a federated domain relationship between the domains 102 and 112.

In step 302, a request for a federated domain relationship is sent to the domain with which the relationship is desired (e.g., the domain 112). In step 304, a determination is made as to whether the request has been granted (e.g., based upon a received response). If the request was not granted, the method 300 moves to step 306 and ends without a federated domain relationship being established. If the request was granted, the method 300 continues to step 308.

In step 308, the two access servers exchange domain information. In step 310, the received domain information is stored. In step 312, at least a portion of the received domain information is sent to endpoints within the domain 102.

In step 314, a determination is made as to whether any updates (e.g., additional or modified information) have been received from the domain 112. If not, step 314 may repeat as needed. If updates have been received, the method 300 returns to step 310 and repeats steps 310 and 312 before returning to step 314.

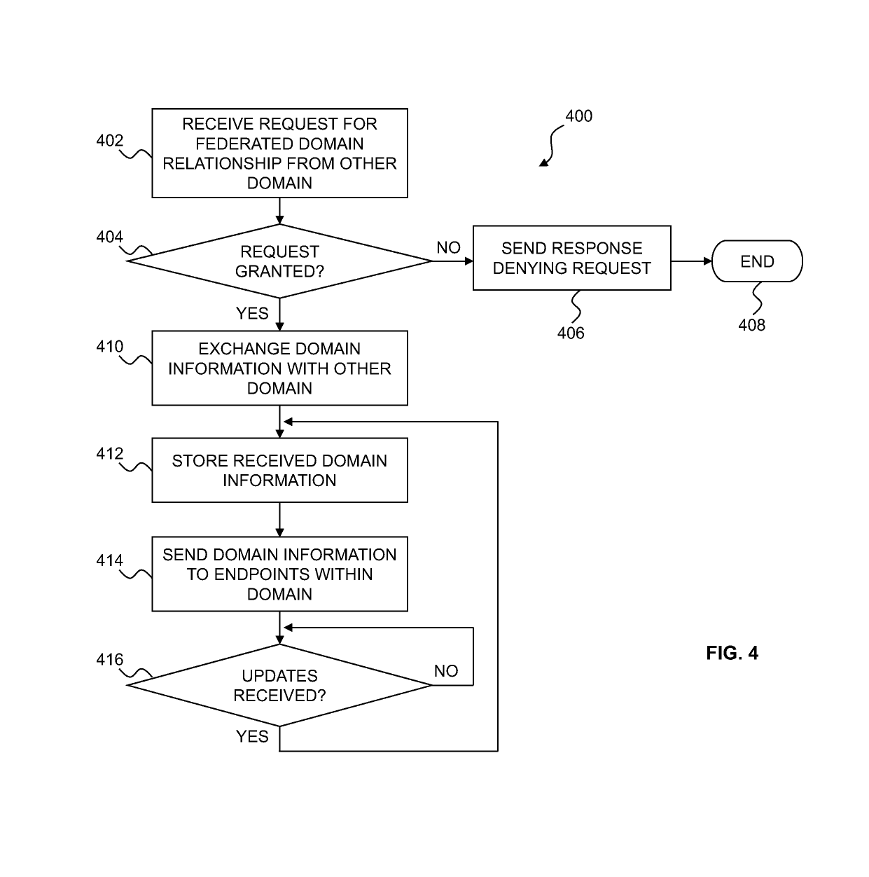

Referring to FIG. 4, a method 400 illustrates one embodiment of a process that may be executed by an access server (e.g., the access server 114 of FIG. 1) to establish a federated domain relationship. For purposes of example, the access server 114 is communicating with the access server 104 to establish a federated domain relationship between the domains 112 and 102.

In step 402, a request for a federated domain relationship is received from the domain desiring the relationship (e.g., the domain 102). In step 404, a determination is made as to whether the request has been granted (e.g., based upon received input or a configuration file). For example, a control panel of the access server 114 may display the received request and wait for user input to grant or deny the request. If the request was not granted, the method 400 moves to step 406, where a response is sent indicating that the request was denied. The method 400 then moves to step 408 and ends without a federated domain relationship being established.

If the request was granted, the method 400 continues to step 410. Steps 410-416 are similar or identical to steps 308-314 of FIG. 3 and are not described in detail herein.

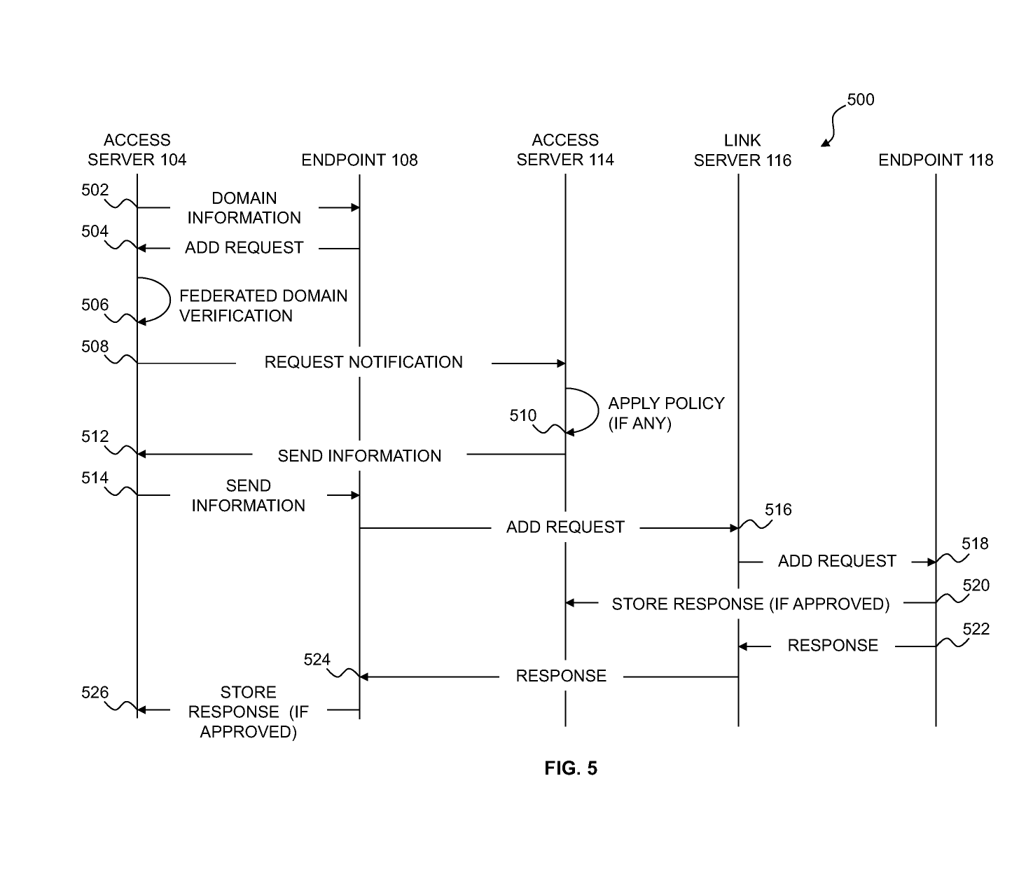

Referring to FIG. 5, a sequence diagram 500 illustrates one embodiment of a process that may be executed when an endpoint in one domain attempts to add an endpoint in another domain as a buddy. In the present embodiment, the two domains are in a federated domain relationship and both endpoints are online.

After the process of FIG. 2 is executed, an endpoint in one of the domains 102 or 112 is able to communicate with the infrastructure of the other domain, but is not yet able to communicate with an endpoint in the other domain. For example, the endpoint 108 of the domain 102 can now communicate with the access server 114 and link server 116 of the domain 112, but cannot communicate with the endpoints 118 and 120 at this time. In other words, the federated domain relationship does not mean that endpoints can automatically communicate with one another. In the present embodiment, both user preferences (e.g., whether a buddy request is accepted or rejected) and/or various domain level policies may affect an endpoint's ability to communicate across domains with another endpoint.

In step 502, which is identical to step 212 of FIG. 2, the endpoint 108 receives information about the domain 112. This may occur during an update if the endpoint 108 is online or may occur when the endpoint 108 logs into the domain 102. For example, the information may be sent to the endpoint 108 as part of or along with profile information received by the endpoint 108 as it logs into the peer-to-peer network as described in U.S. Pat. No. 8,725,895.

In step 504, the endpoint 108 sends an add request to the access server 104, indicating that the endpoint 108 wants to add an endpoint within the domain 112 as a buddy. The add request may identify a particular endpoint (e.g., the federated contact that is the endpoint 118) or may simply identify that the endpoint 108 wants to add a buddy that is located in the domain 112.

In step 506, the access server 104 verifies that the request is about an endpoint in a federated domain. If the request is about an endpoint that is not in a federated domain, the access server 104 responds to the endpoint 108 with a denial of the request (not shown). If the request is about an endpoint in a federated domain (as shown), the access server 104 sends a notification to the access server 114 about the request in step 508. The notification may include such information as the identity of the federated contact and any available information about that endpoint, such as its public and/or private IP address and port information.

In step 510, the access server 114 applies any policies that may be defined within the domain 112 to the request. For example, policies may be defined for requests coming from any federated domain, for requests coming specifically from the domain 102, for requests from a specific endpoint in a federated domain, and/or for requests directed to specific endpoints within the domain 112. If the application of any policies results in a denial of the request by the access server 114, the access server 114 would respond to the access server 104 with the denial (not shown). If the application of any policies does not result in a denial of the request, the access server 114 responds to the access server 104 with contact information of the endpoint 118 needed for the request in step 512. The response may include the federated contact and any associated information if that endpoint is online, such as its public and/or private IP address and port information.

In step 514, the access server 104 sends the information to the endpoint 108. In step 516, the endpoint 108 sends an add request to the link server 116 of the domain 112. In step 518, the link server 116 sends the request to the endpoint 118. In step 520, the endpoint 118 stores its response in the access server 114 if the response approves the request. If the response denies the request, the response may not be stored.

In step 522, the endpoint 118 sends its response to the link server 116. In step 524, the link server 116 sends the response to the endpoint 108. In step 526, the endpoint 108 stores the response in the access server 104 if the response approves the request. If the response denies the request, the response may not be stored.

At this point, the domains 102 and 112 are in a federated domain relationship and the endpoint 118 has granted permission to the endpoint 108 to establish a communication session (e.g., the endpoints 108 and 118 are buddies). The two endpoints 108 and 118 can now communicate with one another across the boundary separating the domains 102 and 112.

In embodiments where the endpoint 118 is offline and cannot respond to the request of step 518, the link server 116 and/or access server 114 may store the request until the endpoint 118 comes online. The request may then be forwarded as shown in step 518.

In embodiments where the endpoint 108 sends the request and then goes offline before the response is received, the link server 116 and/or access server 114 may store the response until the endpoint 108 comes online. The response may then be forwarded to the endpoint 108 as shown in step 524. If the access server 114 stores the response, the link server 116 may forward the response to the access server 114.

Alternatively, the link server 116 may forward the response to the access server 104 and/or the link server 106, or the access server 104 may forward the response to the link server 106. The response may be stored until the endpoint 108 comes online, at which time the response may be forwarded to the endpoint 108 by the access server 104 or the link server 106.

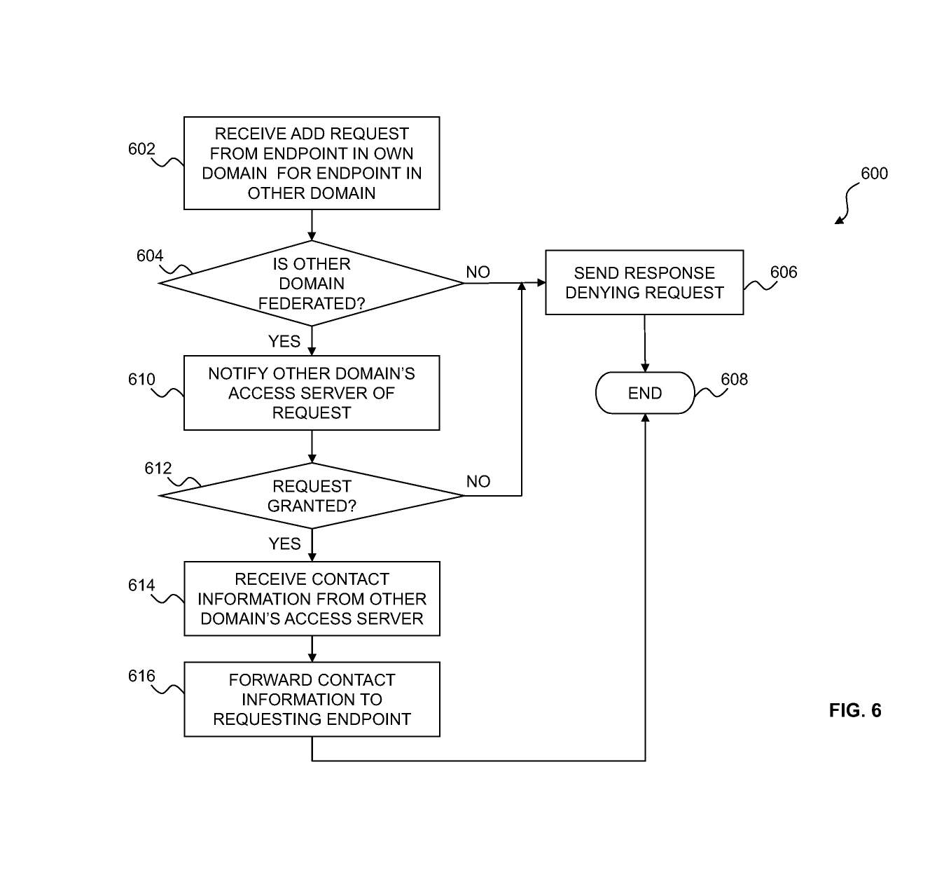

Referring to FIG. 6, a method 600 illustrates one embodiment of a process that may be executed by an access server (e.g., the access server 104 of FIG. 1) to aid an endpoint (e.g., the endpoint 108) in establishing a buddy relationship with an endpoint (e.g., the endpoint 118) in a federated domain.

In step 602, an add request is received from the endpoint 108 that is in the same domain as the access server 104. The add request identifies an endpoint in another domain with which the endpoint 108 wants to establish a buddy relationship. In step 604, a determination is made as to whether the endpoint 118 is in a domain that is in a federated domain relationship with the domain 102 in which the access server 104 is located. If the domains are not in a federated domain relationship, a response is sent to the endpoint 108 denying the request in step 606 and the method 600 then ends in step 608. If the domains are in a federated domain relationship, the method 600 moves to step 610.

In step 610, an access server (e.g., the access server 114) in the other domain is notified of the request. In step 612, a determination is made as to whether the request has been granted by the other domain. If the request has not been granted, a response is sent to the endpoint 108 denying the request in step 606 and the method 600 then ends in step 608. If the request has been granted, the access server 104 receives contact information for the endpoint 118 from the access server 114. It is understood that steps 612 and 614 may occur simultaneously, with a response to the request containing the contact information and acknowledging that the request has been granted. In step 616, the contact information is forwarded to the endpoint 108 and the method 600 ends.

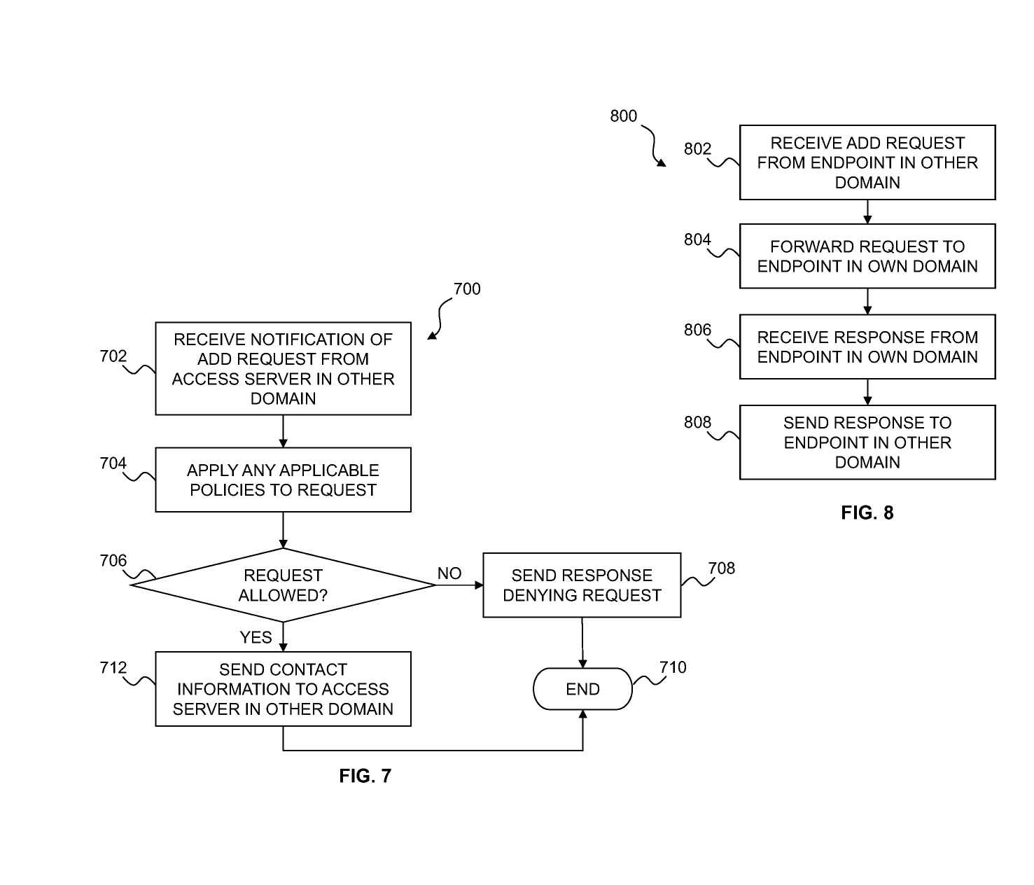

Referring to FIG. 7, a method 700 illustrates one embodiment of a process that may be executed by an access server (e.g., the access server 114 of FIG. 1) to aid an endpoint (e.g., the endpoint 108) in a federated domain in establishing a buddy relationship with an endpoint (e.g., the endpoint 118) in the same domain as the access server.

In step 702, a notification of the add request is received from the other domain (e.g., from the access server 104). In step 704, any applicable policies are applied to the request. Such policies may restrict contact to certain endpoints, may restrict the behavior of another domain's endpoints within the domain 112, and/or may control any aspect of communications between the domains 102 and 112 for which a policy can be enacted.

In step 706, a determination is made as to whether the request is allowed based on the applied policies (if any). If the request has been denied, a response is sent to the access server 104 denying the request in step 708 and the method 600 then ends in step 710. If the request has been granted, contact information for the endpoint 118 is sent to the access server 104 in step 712 and the method 700 then ends.

Referring to FIG. 8, a method 800 illustrates one embodiment of a process that may be executed by a link server (e.g., the link server 116 of FIG. 1) to aid an endpoint (e.g., the endpoint 108) in a federated domain in establishing a buddy relationship with an endpoint (e.g., the endpoint 118) in the same domain as the link server.

In step 802, the add request is received from the endpoint 108. In step 804, the request is sent to the endpoint 118. In step 806, a response is received from the endpoint 118. In step 808, the response is sent to the endpoint 108.

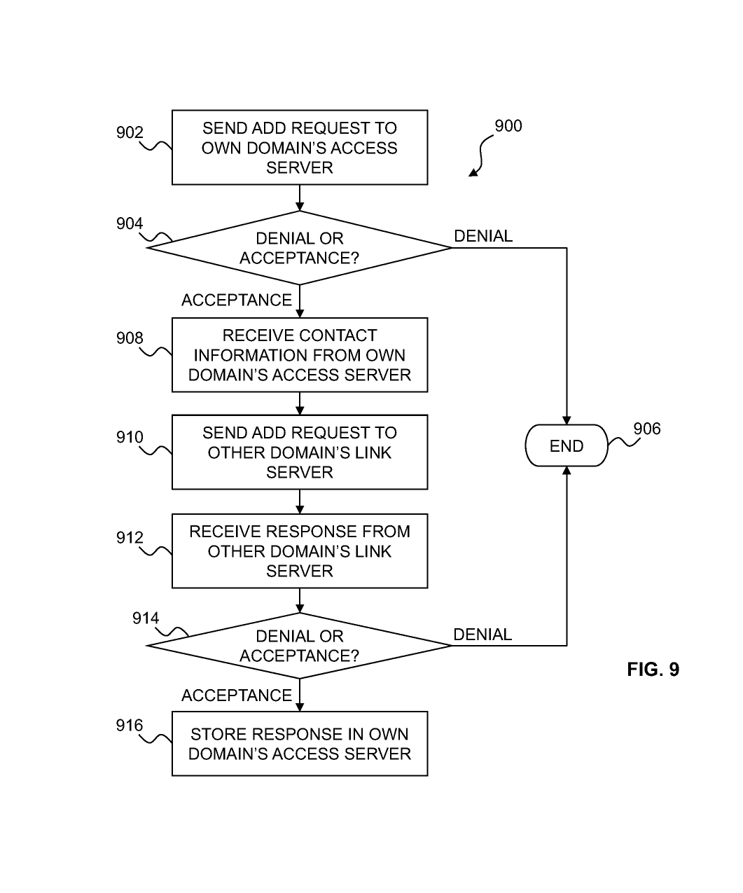

Referring to FIG. 9, a method 900 illustrates one embodiment of a process that may be executed by an endpoint (e.g., the endpoint 108 of FIG. 1) to establish a buddy relationship with an endpoint (e.g., the endpoint 118) in a federated domain.

In step 902, an add request is sent to an access server (e.g., the access server 104) in the endpoint's own domain 102. In step 904, a determination is made as to whether the request was accepted or denied. If the request was denied, the method 900 moves to step 906 and ends. If the request was accepted, contact information for the endpoint 118 is received in step 908.

In step 910, an add request is sent to a link server (e.g., the link server 116) in the domain 112. In step 912, a response to the add request is received from the link server 116. In step 914, a determination is made as to whether the request was accepted or denied. If the request was denied, the method 900 moves to step 906 and ends. If the request was accepted, the response is stored in the access server 104 in step 916.

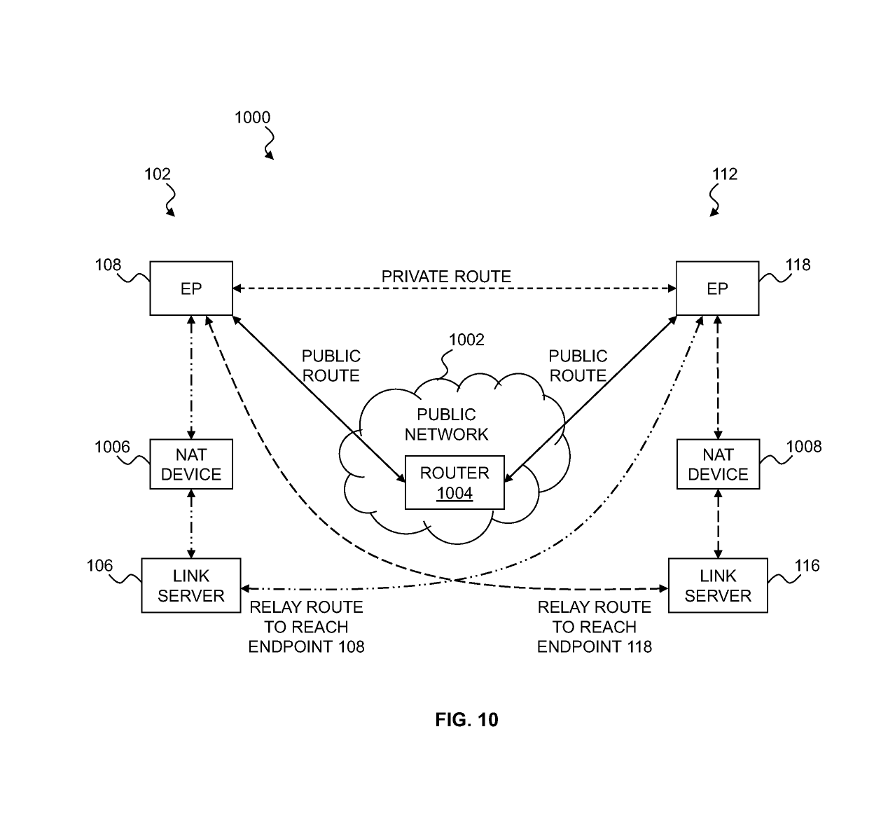

Referring to FIG. 10, one embodiment of an environment 1000 is illustrated that is similar or identical to the environment 100 of FIG. 1. In the present example, the domains 102 and 112 are in a federated domain relationship and the endpoint 108 has established a buddy relationship with the endpoint 118.

As described in U.S. Pat. No. 8,725,895, there are three possible communication routes from the endpoint 108 to the endpoint 118 and from the endpoint 118 to the endpoint 108. For each side, there is a private route, a public route, and a relay route. The private route (which may go through a local area network (LAN) (not shown)) may be discovered and used as described in U.S. Pat. No. 8,725,895. Similarly, the public route (which may go through a public network 1002 and one or more routers 1004) may be discovered and used as described in U.S. Pat. No. 8,725,895. However, the relay route in the present example may vary somewhat from that described in U.S. Pat. No. 8,725,895.

The relay route is needed when an endpoint is behind a symmetric (e.g., NAT 5) firewall and can only be reached via a relay router (e.g., a link server or access server). However, only a relay router in the protected endpoint's own domain will have a pinhole open for the protected endpoint. Accordingly, in the present example of communications occurring across federated domain boundaries, an endpoint in one domain may leverage the relay router in the other domain to reach a protected endpoint.

For example, the endpoint 108 is behind a NAT device 1006 that is a symmetric NAT. The endpoint 108 has established a pinhole with the link server 106. In order to communicate with the endpoint 108, the endpoint 118 will communicate with the link server 106, which will route the communications through the pinhole in the NAT device 1006 to the endpoint 108.

If the endpoint 118 is not behind a NAT device 1008 that requires a pinhole, the endpoint 108 can communicate normally with the endpoint 118 (e.g., via the private route or public route). However, if the endpoint 118 is behind the NAT device 1008 that requires a pinhole, the endpoint 108 will communicate with the link server 116, which will route the communications through the pinhole in the NAT device 1008 to the endpoint 118. Accordingly, by using the link server (or other relay router) in the opposite federated domain, an endpoint can communicate with another endpoint that is protected by a symmetric NAT device.

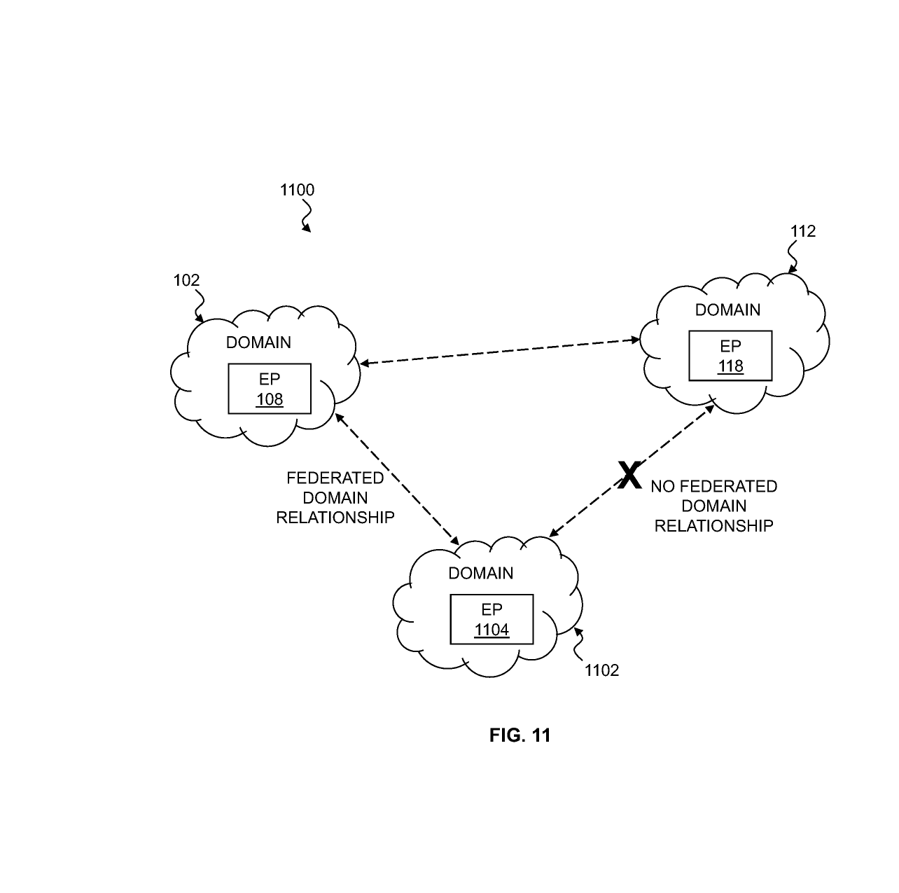

With additional reference to FIG. 11, one embodiment of an environment 1100 is illustrated that is similar or identical to the environment 100 of FIG. 1 with an additional domain 1102. In the present example, the domain 102 is in one federated domain relationship with the domain 112 and in another federated domain relationship with the domain 1102. The domains 112 and 1102 are not in a federated domain relationship.

The endpoint 108 can establish connections with the endpoint 118 in the domain 112 and an endpoint 1104 in the domain 1102. However, the endpoints 118 and 1104 cannot connect directly to each other because the domains 112 and 1102 are not in a federated domain relationship. Accordingly, the endpoint 108 may serve as a bridge for the endpoints 118 and 1104 in some embodiments, enabling communication between endpoints that cannot ordinarily communicate.

In order to bridge the communication session, the endpoint 108 would first establish separate connections with the endpoint 118 and the endpoint 1104 as described above. The endpoint 108 would then relay communications received from the endpoint 118 to the endpoint 1104 and relay communications received from the endpoint 1104 to the endpoint 118.

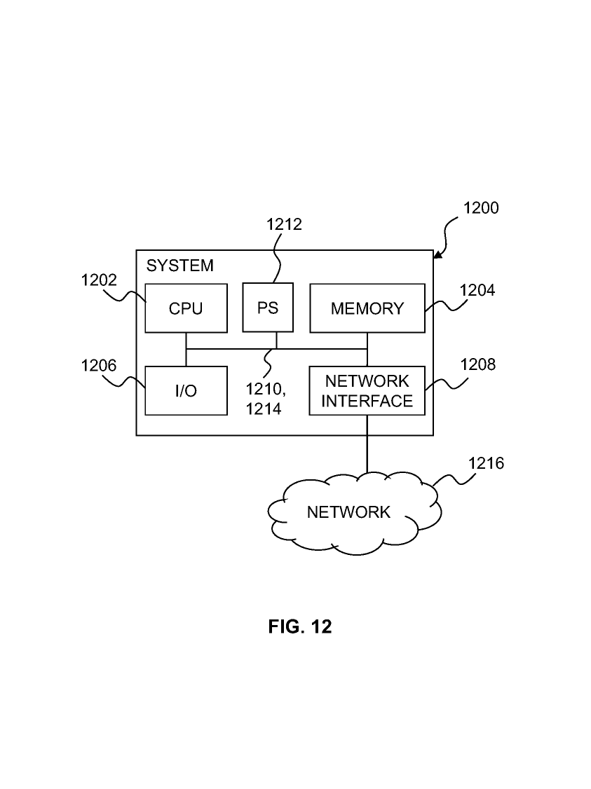

Referring to FIG. 12, one embodiment of a system 1200 is illustrated. The system 1200 is one possible example of a device such as an access server, link server, and/or endpoint of FIG. 1. Embodiments of the device 1200 include cellular telephones (including smart phones), personal digital assistants (PDAs), netbooks, tablets, laptops, desktops, workstations, servers, telepresence consoles, and any other computing device that can communicate with another computing device using a wireless and/or wireline communication link. Such communications may be direct (e.g., via a peer-to-peer network, an ad hoc network, or using a direct connection), indirect, such as through a server or other proxy (e.g., in a client-server model), or may use a combination of direct and indirect communications. It is understood that the system 1200 may be implemented in many different ways and by many different types of systems, and may be customized as needed to operate within a particular environment.

The system 1200 may include a controller (e.g., a central processing unit (“CPU”)) 1202, a memory unit 1204, an input/output (“I/O”) device 1206, and a network interface 1208. The components 1202, 1204, 1206, and 1208 are interconnected by a transport system (e.g., a bus) 1210. A power supply (PS) 1212 may provide power to components of the computer system 1200, such as the CPU 1202 and memory unit 1204, via a power system 1214 (which is illustrated with the transport system 1210 but may be different).

It is understood that the system 1200 may be differently configured and that each of the listed components may actually represent several different components. For example, the CPU 1202 may actually represent a multi-processor or a distributed processing system; the memory unit 1204 may include different levels of cache memory, main memory, hard disks, and remote storage locations; the I/O device 1206 may include monitors, keyboards, and the like; and the network interface 1208 may include one or more network cards providing one or more wired and/or wireless connections to a network 1216. Therefore, a wide range of flexibility is anticipated in the configuration of the system 1200.

The system 1200 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, servers, and embedded devices depending on the use of the system 1200. The operating system, as well as other instructions, may be stored in the memory unit 1204 and executed by the processor 1202. For example, if the system 1200 is an access server, link server, or endpoint, the memory unit 1204 may include instructions for performing the applicable methods described herein.

While the preceding description shows and describes one or more embodiments, it will be understood by those skilled in the art that various changes in form and detail may be made therein without departing from the spirit and scope of the present disclosure. For example, various steps illustrated within a particular flow chart or sequence diagram may be combined or further divided. In addition, steps described in one flow chart or diagram may be incorporated into another flow chart or diagram. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a method for providing connectivity in a federated domain relationship includes sending, by a first access server in a first domain, a federated domain request for a federated domain relationship to a second access server in a second domain, wherein the federated domain relationship enables a plurality of endpoints within each of the otherwise separate first and second domains to communicate with a plurality of endpoints in the other of the first and second domains; receiving, by the first access server, a response to the federated domain request, wherein the response indicates that the federated domain request is granted; sending, by the first access server, first domain information about the first domain to the second access server; receiving, by the first access server, second domain information about the second domain from the second access server; and sending, by the first access server, at least a portion of the second domain information to the endpoints in the first domain.

In some embodiments, the method further includes receiving, by the first access server, updated information about the second domain from the second access server; and sending, by the first access server, at least a portion of the updated domain information to the endpoints in the first domain.

In some embodiments, the method further includes receiving, by the first access server, an add request from a first endpoint of the endpoints in the first domain, wherein the add request identifies a second endpoint of the endpoints in the second domain with which the first endpoint wants to communicate; notifying, by the first access server, the second access server of the add request; receiving, by the first access server, contact information for the second endpoint from the second access server if the add request is granted by at least one of the second access server and the second endpoint; and forwarding, by the first access server, the contact information to the first endpoint.

In some embodiments, the method further includes receiving, by the first access server, an add request from a first endpoint of the endpoints in the first domain, wherein the add request identifies a second endpoint of the endpoints in the second domain with which the first endpoint wants to communicate; notifying, by the first access server, the second access server of the add request; and sending, by the first access server, a response to the first endpoint indicating that the add request has been denied if the add request is denied by at least one of the second access server and the second endpoint.

In some embodiments, the method further includes receiving, by the first access server, an add request from the second access server, wherein the add request identifies that a second endpoint of the endpoints in the second domain wants to communicate with a first endpoint of the endpoints in the first domain; and determining, by the first access server, whether the add request should be granted or denied.

In some embodiments, the method further includes sending, by the first access server, contact information for first endpoint to the second access server if the determining indicates that the add request should be granted.

In some embodiments, the method further includes sending, by the first access server, a message to the second access server denying the add request if the determining indicates that the add request should be denied.

In some embodiments, the determining includes applying, by the first access server, a policy to the add request.

In some embodiments, sending the first domain information about the first domain to the second access server includes sending an Internet Protocol address of a link server in the first domain.

In some embodiments, sending at least a portion of the second domain information to the endpoints in the first domain includes sending an Internet Protocol address of at least one of the second access server and a link server in the second domain.

In another embodiment, a method providing connectivity between endpoints in different domains that have a federated domain relationship includes receiving, by a first access server in a first domain, an add request from a first endpoint in the first domain, wherein the add request identifies a second endpoint in a second domain with which the first endpoint wants to communicate; determining, by the first access server, that the first domain has a federated domain relationship with the second domain, wherein the federated domain relationship enables endpoints within the first domain to communicate with endpoints within the second domain; sending, by the first access server, a notification of the add request to the second access server; and receiving, by the first access server, a response to the notification from the second access server either granting or denying the add request.

In some embodiments, the method further includes receiving, by the first access server, contact information for the second endpoint from the second access server if the add request is granted by at least one of the second access server and the second endpoint; and forwarding, by the first access server, the contact information to the first endpoint, wherein the first endpoint is able to use the contact information to attempt to contact the second endpoint.

In some embodiments, the method further includes storing, by the first access server, an acceptance notification received from the first endpoint.

In some embodiments, the method further includes sending, by the first access server, a response to the first endpoint indicating that the add request has been denied if the add request is denied by at least one of the second access server and the second endpoint.

In yet another embodiment, a method for execution by an endpoint includes sending, by a first endpoint in a first domain, a first add request to an access server in the first domain, wherein the first add request identifies a second endpoint in a second domain with which the first endpoint wants to communicate, wherein the first domain has a federated domain relationship with the second domain that enables endpoints within the first domain to communicate with endpoints within the second domain, and wherein the first endpoint has previously received information about the second domain from the access server; and receiving, by the first endpoint, a denial or approval of the first add request from the access server.

In some embodiments, the method further includes receiving, by the first endpoint, contact information for the second endpoint from the access server if the first add request was approved; sending, by the first endpoint, a second add request to at least one of an access server in the second domain and a link server in the second domain; and receiving, by the first endpoint, a denial or acceptance of the second add request.

In some embodiments, the method further includes storing, by the first endpoint, an acceptance to the second add request on the access server in the first domain if the second add request was accepted.

In some embodiments, the method further includes establishing, by the first endpoint, a communication session with the second endpoint if the second add request was accepted.

In some embodiments, the communication session is established directly with the second endpoint.

In some embodiments, the communication session is established with the second endpoint via the link server.

In some embodiments, the method further includes sending, by the first endpoint, a second add request to the access server, wherein the second add request identifies a third endpoint in a third domain with which the first endpoint wants to communicate, wherein the first domain has a federated domain relationship with the third domain that enables endpoints within the first domain to communicate with endpoints within the third domain, and wherein the second endpoint and the third endpoint cannot communicate with one another directly because the second domain is not in a federated domain relationship with the third domain; receiving, by the first endpoint, an approval of the first add request and the second add request; and establishing a communication session with the second endpoint and the third endpoint, wherein the first endpoint operates as a bridge between the second endpoint and the third endpoint during the communication session.

In still other embodiments, a system, device, or apparatus includes a network interface, a processor coupled to the network interface, and a memory coupled to the processor and containing a plurality of instructions for execution by the processor, wherein the instructions include instructions for executing any of the methods disclosed herein.

What is claimed is:

1. A method for providing connectivity in a federated domain relationship, the method comprising:
sending, by a first access server in a first domain, a federated domain request for a federated domain relationship to a second access server in a second domain, wherein the federated domain relationship enables a plurality of endpoints within each of the otherwise separate first and second domains to communicate with a plurality of endpoints in the other of the first and second domains;
receiving, by the first access server, a response to the federated domain request, wherein the response indicates that the federated domain request is granted;
sending, by the first access server, first domain information about the first domain to the second access server;
receiving, by the first access server, second domain information about the second domain from the second access server; and
sending, by the first access server, at least a portion of the second domain information to the endpoints in the first domain.

2. The method of claim 1 further comprising:
receiving, by the first access server, updated information about the second domain from the second access server; and
sending, by the first access server, at least a portion of the updated domain information to the endpoints in the first domain.

3. The method of claim 1 further comprising:
receiving, by the first access server, an add request from a first endpoint of the endpoints in the first domain, wherein the add request identifies a second endpoint of the endpoints in the second domain with which the first endpoint wants to communicate;
notifying, by the first access server, the second access server of the add request;
receiving, by the first access server, contact information for the second endpoint from the second access server if the add request is granted by at least one of the second access server and the second endpoint; and
forwarding, by the first access server, the contact information to the first endpoint.

4. The method of claim 1 further comprising:
receiving, by the first access server, an add request from a first endpoint of the endpoints in the first domain, wherein the add request identifies a second endpoint of the endpoints in the second domain with which the first endpoint wants to communicate;
notifying, by the first access server, the second access server of the add request; and
sending, by the first access server, a response to the first endpoint indicating that the add request has been denied if the add request is denied by at least one of the second access server and the second endpoint.

5. The method of claim 1 further comprising:
receiving, by the first access server, an add request from the second access server, wherein the add request identifies that a second endpoint of the endpoints in the second domain wants to communicate with a first endpoint of the endpoints in the first domain; and
determining, by the first access server, whether the add request should be granted or denied.

6. The method of claim 5 further comprising sending, by the first access server, contact information for first endpoint to the second access server if the determining indicates that the add request should be granted.

7. The method of claim 5 further comprising sending, by the first access server, a message to the second access server denying the add request if the determining indicates that the add request should be denied.

8. The method of claim 5 wherein the determining includes applying, by the first access server, a policy to the add request.

9. The method of claim 1 wherein sending the first domain information about the first domain to the second access server includes sending an Internet Protocol address of a link server in the first domain.

10. The method of claim 1 wherein sending at least a portion of the second domain information to the endpoints in the first domain includes sending an Internet Protocol address of at least one of the second access server and a link server in the second domain.

11. A method for providing connectivity between endpoints in different domains that have a federated domain relationship, the method comprising:
receiving, by a first access server in a first domain, an add request from a first endpoint in the first domain, wherein the add request identifies a second endpoint in a second domain with which the first endpoint wants to communicate;
determining, by the first access server, that the first domain has a federated domain relationship with the second domain, wherein the federated domain relationship enables endpoints within the first domain to communicate with endpoints within the second domain;
sending, by the first access server, a notification of the add request to the second access server; and
receiving, by the first access server, a response to the notification from the second access server either granting or denying the add request.

12. The method of claim 11 further comprising:
receiving, by the first access server, contact information for the second endpoint from the second access server if the add request is granted by at least one of the second access server and the second endpoint; and
forwarding, by the first access server, the contact information to the first endpoint, wherein the first endpoint is able to use the contact information to attempt to contact the second endpoint.

13. The method of claim 12 further comprising storing, by the first access server, an acceptance notification received from the first endpoint.

14. The method of claim 11 further comprising sending, by the first access server, a response to the first endpoint indicating that the add request has been denied if the add request is denied by at least one of the second access server and the second endpoint.

15. A method for execution by an endpoint, the method comprising:
sending, by a first endpoint in a first domain, a first add request to an access server in the first domain, wherein the first add request identifies a second endpoint in a second domain with which the first endpoint wants to communicate, wherein the first domain has a federated domain relationship with the second domain that enables endpoints within the first domain to communicate with endpoints within the second domain, and wherein the first endpoint has previously received information about the second domain from the access server; and
receiving, by the first endpoint, a denial or approval of the first add request from the access server.

16. The method of claim 15 further comprising:
receiving, by the first endpoint, contact information for the second endpoint from the access server if the first add request was approved;
sending, by the first endpoint, a second add request to at least one of an access server in the second domain and a link server in the second domain; and
receiving, by the first endpoint, a denial or acceptance of the second add request.

17. The method of claim 16 further comprising storing, by the first endpoint, an acceptance to the second add request on the access server in the first domain if the second add request was accepted.

18. The method of claim 16 further comprising establishing, by the first endpoint, a communication session with the second endpoint if the second add request was accepted.

19. The method of claim 18 wherein the communication session is established directly with the second endpoint.

20. The method of claim 18 wherein the communication session is established with the second endpoint via the link server.

21. The method of claim 15 further comprising:
sending, by the first endpoint, a second add request to the access server, wherein the second add request identifies a third endpoint in a third domain with which the first endpoint wants to communicate, wherein the first domain has a federated domain relationship with the third domain that enables endpoints within the first domain to communicate with endpoints within the third domain, and wherein the second endpoint and the third endpoint cannot communicate with one another directly because the second domain is not in a federated domain relationship with the third domain;
receiving, by the first endpoint, an approval of the first add request and the second add request; and
establishing a communication session with the second endpoint and the third endpoint, wherein the first endpoint operates as a bridge between the second endpoint and the third endpoint during the communication session.
